(19) United States
(12) Patent Application Publication
(10) Pub. No.: US 2026/0134488 A1
(43) Pub. Date: May 14, 2026

(54) ARTIFICIAL INTELLIGENCE METHOD FOR EVALUATING A MINING PROJECT

(71) Applicant: Schlumberger Technology Corporation, Sugar Land, TX (US)

(72) Inventors: Denis Heliot, Sugar Land, TX (US); Lina Xu, Houston, TX (US); Valerian Guillot, Montpellier (FR)

(21) Appl. No.: 19/378,605

(22) Filed: Nov. 4, 2025

Related U.S. Application Data
(60) Provisional application No. 63/718,880, filed on Nov. 11, 2024.

(51) Int. Cl. G06Q 50/02; G06Q 10/0631

(52) U.S. Cl. CPC G06Q 50/02; G06Q 10/06313

(57) ABSTRACT

A method for evaluating a mining site as a potential candidate for application of an emerging mining technology includes acquiring at least one report that provides information about the mining site and generating evaluation queries and criteria related to an application of the emerging mining technology to the mining site. An artificial intelligence (AI) based engine is used to extract query relevant information from the at least one acquired report; classify the extracted query relevant information using the generated criteria; and generate an applicability score that assesses the viability of utilizing the emerging mining technology to mine the mining site.

### CROSS REFERENCE TO RELATED APPLICATIONS

This application claims the benefit of U.S. Provisional Application Ser. No. 63/718,880 entitled Artificial Intelligence Method for Evaluating a Mining Project, filed Nov. 11, 2024, which is incorporated herein by reference in its entirety.

### BACKGROUND

Developing a mining project often requires massive investment and both financial and environmental risk mitigation. However, as technology develops and matures, some mining sites that were previously deemed to be non-economical, borderline economical, or economical but too risky, may become economically favorable and/or less risky. One example of an emerging, and potentially enabling, mining technology is in-situ mining (also commonly referred to as in-situ leaching or in-situ recovery), or variants thereof such as electrokinetic assisted in-situ mining or in-situ biomining.

Industrial scale mining projects are complex projects that generate large quantities of data and other information. Such information can include environmental impact studies, economic feasibility analysis, geological surveys, detailed engineering reports, and so on. Much of this information is made publicly available. For example, National Instrument (NI) 43-101 governs how companies disclose mining-related information in Canada. The NI 43-101 stipulates the form and content of mining reports with the intent to promote accuracy in reporting and prevent publication of deceptive or erroneous information. Many other countries have similar reporting requirements.

One difficulty with identifying potential target sites that may benefit from the application of new mining technologies is the sheer quantity of available information. For example, the aforementioned mining reports can be hundreds of pages (or even a thousand pages) or more in length for a single mining site. Reviewing and evaluating these reports is a daunting task and often requires highly educated (and expensive) analysts. There is a need in the industry for an improved method for screening and evaluating publicly available mining reports to assess the viability of new technology.

### SUMMARY

Methods and systems for evaluating a mining site as a potential candidate for application of an emerging mining technology are disclosed. In one example embodiment a method includes acquiring at least one report that provides information about the mining site and generating evaluation queries and criteria related to an application of the emerging mining technology to the mining site. An artificial intelligence (AI) based engine is used to extract query relevant information from the at least one acquired report; classify the extracted query relevant information using the generated criteria; and generate an applicability score that assesses the viability of utilizing the emerging mining technology to mine the mining site.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

For a more complete understanding of the disclosed subject matter, and advantages thereof, reference is now made to the following descriptions taken in conjunction with the accompanying drawings, in which:

FIG. 1 depicts a flow chart of one example method 100 for evaluating a mining site as a potential target for a new mining technology.

FIGS. 2A and 2B (collectively FIG. 2) depict block diagrams, of example AI based systems for executing the method shown on FIG. 1.

FIG. 3 depicts a table including example classification criteria for an in-situ leaching evaluation.

FIGS. 4A and 4B (collectively FIG. 4) depict example tabulated results from AI scanning of NI 43-101 reports for a potential mining site.

FIG. 5 depicts another example implementation of a generative AI enabled workflow to identify mining sites where a mining technology may be applicable.

FIG. 6 depicts an example computer system for implementing the methods and systems disclosed in FIGS. 1, 2, and 5.

### DETAILED DESCRIPTION

The disclosed embodiments include artificial intelligence-based systems (and corresponding methods) configured to scan publicly available mining project reports to categorize and identify mining projects/sites where a given technology (particularly a new or emerging technology) may be applied. The system may be configured, for example, to evaluate the site geology, including various geological properties, such as permeability, water table level, ore type and content, and etc. In example embodiments, the system may be further configured to provide specific answers to specific questions about the site geology as well as the economic viability of a potential project.

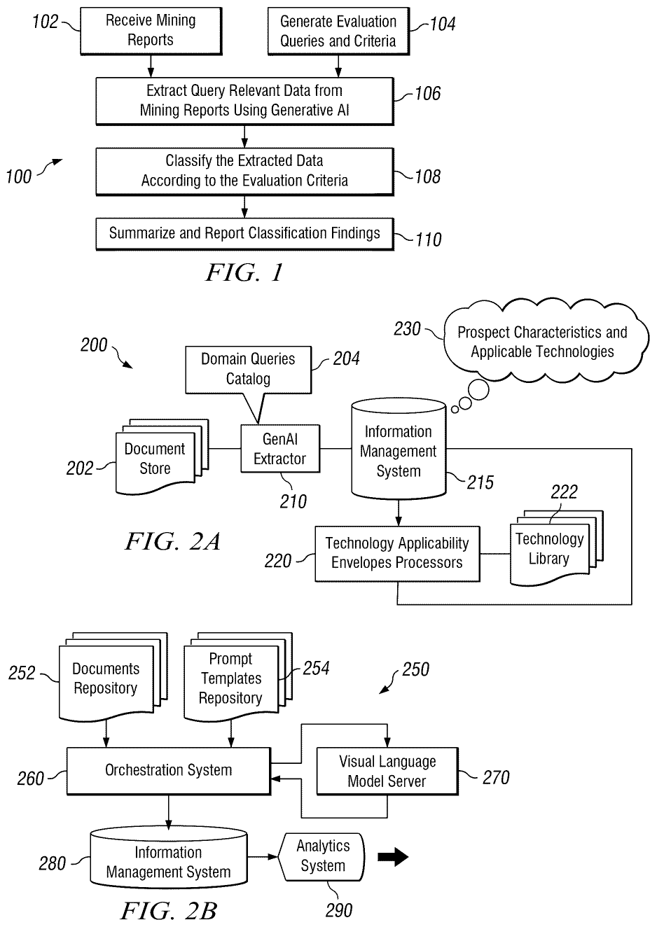

FIG. 1 depicts a flow chart of one example method 100 for evaluating a mining site as a potential target for a new mining technology. The method includes acquiring mining reports relevant to the mining site at 102. The reports may include, for example, publicly available mining reports such as NI 43-101 compliant reports. The reports may further include non-publicly available reports, such as technical reports provided by engineering consultants, geologists, and other specialists as well as other information provided by the site owner.

Evaluation queries and criteria related to an application of the emerging mining technology to the mining site may be generated at 104. Recognizing that AI algorithms often struggles with vague questions, the queries are advantageously clear and direct. For example, to determine the applicability of in situ leaching technology to a specific site, the queries and criteria may be generated to evaluate whether or not the formation in which the ore body resides is permeable, is under the local water table, and includes sufficient quantity of a mineable mineral such that a potential operation may be economically feasible and/or defendable. As such, the queries may inquire about the presence of specific mineral types and the amounts or the composition of the ore body. The queries may further inquire about the depth of the ore as well as the depth of the water table. The queries may further inquire about the permeability of the geological formation in which the ore body resides. The disclosed embodiments are, of course, not limited to any particular queries or subject matter. For example, different queries may be used depending on the particular emerging mining technology, such as in situ leaching, electrokinetic in situ leaching, in situ biomining.

It will be appreciated that the disclosed embodiments may be particularly well suited to evaluating historical mining sites for more newly developed in situ mining methods such as the aforementioned in situ leaching, electrokinetic in situ leaching, and/or in situ biomining. Those of ordinary skill in the mining industry will readily appreciate that in situ leaching is commonly also referred to as in situ recovery or solution mining and is a mining process that is used to extract minerals, such as copper or uranium, from a borehole (or boreholes) drilled into an ore deposit. A leaching solution is then pumped into the boreholes and into contact with the ore to dissolve the minerals of interest. Electrokinetic in situ leaching is similar to in situ leaching but further uses electrical fields to induce the selective dissolution of the minerals and transport of the charged ions. In situ biomining (also referred to as bioleaching) makes use of specific microorganisms to extract the desired minerals directly from the ore deposit. These emerging mining technologies may be advantageous when extracting minerals from deposits that are too deep or thin for profitable use of conventional mining methods (such as open pit mines) and also aim to reduce the environmental footprint of mining by minimizing the need for physical evacuation and/or overburden removal.

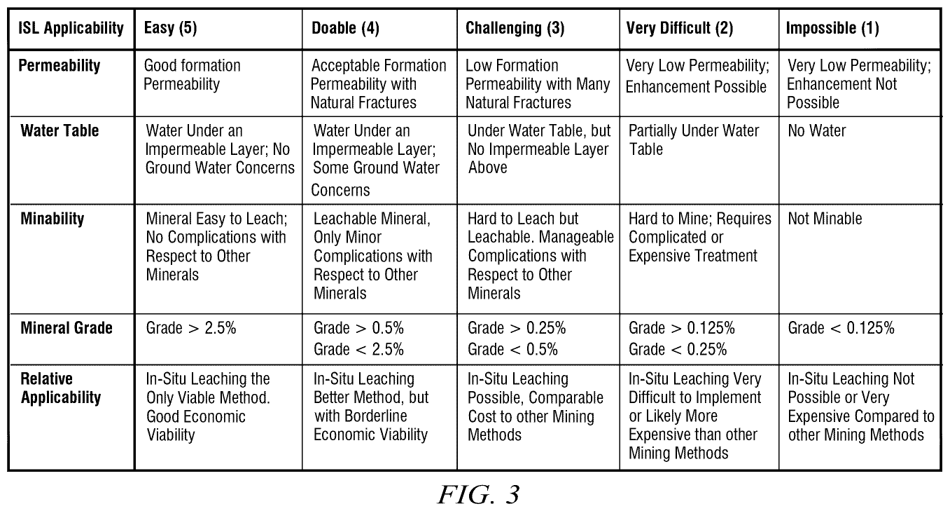

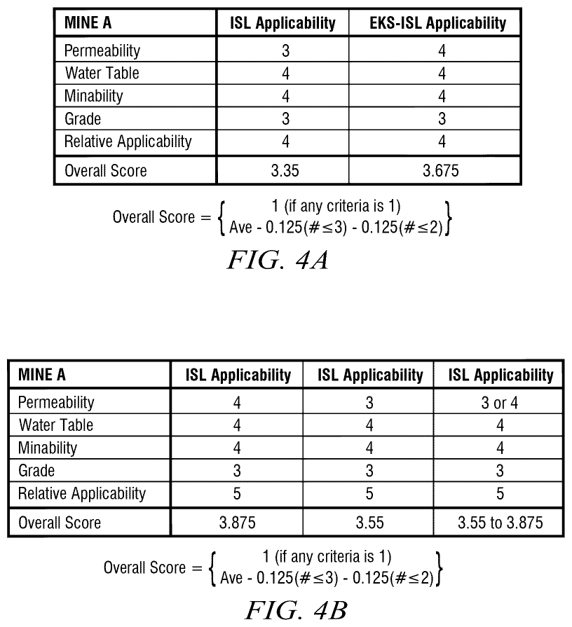

The criteria related to an application of the emerging mining technology may be substantially any suitable criteria suited to evaluating the potential mining site. For example, when the emerging mining technology includes situ leaching, electrokinetic in situ leaching, and/or in situ biomining, the criteria may evaluate the site for mineral extractability via leaching extraction techniques. Example criteria are described in more detail below with respect to FIGS. 3 and 4. Moreover, as also described in more detail below, the criteria may enable the emerging mining technology to be classified using either a binary classifier or a non-binary classifier.

An AI based processing engine may be used to extract query relevant data from the acquired mining reports at 106. The extracted data may include data and other information relevant to the particular subject matter of the queries. For example, the extracted data may include detailed permeability measurements and corresponding permeability values when the queries are related to permeability. In another example, the data may include detailed information relevant to the mineral composition of ore bodies in the mining site or to the depth of the ore body when the queries are related to the mineral composition or mineral depth. Moreover, the extracted data may be text based and/or graphics based. It will be appreciated that the extracted data may be stored in a database or other data repository. The disclosed embodiments are not limited in this regard.

With continued reference to FIG. 1, method 100 further includes classifying or grading the extracted data (or attributes of the mining site based on the extracted data) at 108 according to specific evaluation criteria generated at 104. For example, the extracted data may be classified according to a binary scale (e.g., pass or fail) or to a non-binary scale ranging from highly favorable to highly unfavorable or from highly feasible to highly unfeasible. Moreover, the extracted data may be classified or graded according to multiple independent criteria. For example, the extracted data may be classified or graded according to various attributes of the mining site such as formation permeability, water table level, mineral content and grade, and etc. As noted above, the classification may be binary or non-binary. Still further, these multiple classifications (or grades) may be combined to provide a final site grade or assessment.

The classification findings may be summarized and reported at 110. In particular, an applicability score may be generated that assesses the viability of utilizing the emerging mining technology to mine the mining site. For example, such a report may include a summary of the site grades and a final assessment of the project viability using the new or enabling mining technology. Moreover, the report may be prepared with various audiences in mind. For example, the report may be tailored to target investors who are primarily interested in economic viability, return on investment, and financial risk. The report may also be tailored to a site owner who may be interested in the property value or a potential change in property value related to a developing or maturing technology. A report may also be targeted towards geologists and/or engineers and may include information pertinent to development of a commercial mine. The report may also be directed towards a technology and service provider who may want to identify potential clients or who may want to quantify a potential market size so as to inform about potential technology investment and deployment opportunities. The disclosed embodiments are, of course, not limited in these regards.

FIGS. 2A and 2B (collectively FIG. 2) depict block diagrams of example generative AI based systems 200, 250 for executing the method shown on FIG. 1. In FIG. 2A, system 200 includes a document store 202 configured to store acquired mining reports. The document store may include a file folder or other suitable storage location for text-based files (e.g., .doc or .docx files) or graphics or vector-based files (e.g., .pdf files). The system 200 further includes a catalog of domain queries 204 (e.g., the evaluation queries described above with respect to FIG. 1). An AI based extractor 210 (e.g., a generative AI based extractor) may be configured to extract relevant data or information from the reports in the document store 202 based on (or to satisfy) the queries in the catalog 204. The extracted data may be stored in an information management system 215 (e.g., a database or spreadsheet).

With continued reference to FIG. 2A, the extracted data or information in the information management system 215 may be further evaluated using a technology applicability envelope processor 220 according to a predefined library 222 of technology criteria (e.g., the evaluation criteria described above with respect to FIG. 1). The processor 220 may be configured to evaluate the data according to one or more sets of criteria. For example, the library 222 may include a single set of criteria pertaining to a corresponding mining technology. Alternatively, the library may include multiple sets of criteria pertaining to corresponding mining technologies. As described above, the processor 220 may be configured to classify or grade the extracted data according to the criteria. The determined classification (or report card) may then be stored in the information management system 215. A summary report or table may then be prepared at 230 for one or more target audiences, for example, as described above.

With still further reference to FIG. 2A, the AI based extractor 210 may include substantially any AI processing engine suitable for extracting the relevant data and/or information from the reports. For example, the AI based extractor 210 may include a large language model (LLM) configured to answer questions or queries and therefore extract the query relevant information from text data in the report(s). The LLM may be configured, for example, to leverage neural network techniques to process and comprehend text data using self-supervised learning techniques. The LLM may include numerous processing layers, for example, including feedforward layers, embedding layers, and attention layers. In example embodiments, a suitable LLM may be trained to identify text data that answers the questions and queries catalogued at 204.

It will be appreciated that the disclosed embodiments are not limited to the use of LLMs but may further include other AI processing engines. For example, the AI based extractor 210 may alternatively and/or additionally make use of a visual language models (VLM) that may be advantageously configured to evaluate image based data in the report(s), such as charts, plots, diagrams, photographs, or other image based information and may enable query relevant information to be extracted from the image based data. A suitable VLM may be configured to integrate computer vision and natural language processing (NLP) to process and understand both visual and textual data and may be configured to extract query relevant data from the images (e.g., by providing a textual description of the images). Suitable VLMs may make use of transformer models, cross modal attention, and pretraining and fine-tuning based upon large data sets. In advantageous embodiments, the AI based extractor may include both LLM and VLM models to efficiently extract query relevant data from both text and image-based data in the reports.

Turning now to FIG. 2B, system 250 is similar to system 200 in that it includes a documents repository 252 configured to store acquired mining reports (e.g., the acquired NI 43-101 reports) and a prompt templates repository 254 that includes a series of domain queries used to extract information from the mining documents in the documents repository 252. An orchestration system 260, in combination with a visual language model (VLM) server 270, is configured to process each document in the document repository 252, extract the relevant pages (or paragraphs or figures) that address the queries in repository 254, apply the template prompts, and send the extracted information and aggregated results to an information management system 280 (e.g., a database).

A suitable VLM server 270 may be configured to answer questions or queries about the images provided or pages. In example embodiments, the use of a VLM, for example, in lieu of a large language model (LLM), may advantageously enable the analysis of image based data in the report(s), such as charts, plots, diagrams, photographs, or other image based information and may enable query relevant information to be extracted from the image based data. However, as described above, the disclosed embodiments are not limited in this regard and the VLM server may alternatively and/or additionally include an LLM server configured to answer questions or queries and therefore extract the query relevant information from text data in the report(s).

With continued reference to FIG. 2B, the extracted information and aggregated results in the information management system 280 may be mined by an analytics system 290 according to one or more sets of technology criteria (e.g., the evaluation criteria described above with respect to FIG. 1). The analytics system 290 may process the results according to criteria pertaining to corresponding mining technologies. Moreover, as described above, the analytics system 290 may be configured to classify or grade the extracted data according to the criteria. The determined classification (or report card) may then be stored in the information management system 280, a summary report or table may be prepared for one or more target audiences, for example, as described above.

Turning now to FIG. 3, a table including example classification criteria for an in-situ leaching (ISL) evaluation is depicted. The depicted example includes a non-binary criteria classification for five distinct evaluation criteria. In other words, the mining site is graded or scored on a digital scale according to the five distinct criteria. As noted above, the classification score may be binary (e.g., yes/no or pass/fail criteria) or other non-binary digital scales (such as three or four level non-binary scales). In this example the digital scale is a five level scale ranging from “easy” (a high score of 5) to “impossible” (a low score of 1) and is listed horizontally, with easy (5) being on the left and impossible (1) being on the right. The five site criteria are listed vertically and include permeability, water table, minability, mineral grade, and a relative applicability (listed from top to bottom). It will be appreciated that this depicted classification is merely an example classification for one example technology platform. It will be further appreciated that the disclosed embodiments are in no way limited by the number of criteria, the particular criteria, nor the number of levels in the grading scheme.

In this particular example, a site may be graded as having the highest level (5) of permeability when the permeability is greater than or equal to a threshold level and the lowest level (1) of permeability when the permeability is very low and there is no option for enhancing the permeability (such as in a soft clay formation). Intermediate levels may be determined based upon reported permeability values, the presence or absence of natural fractures, and the potential to enhance the permeability. For example, in the depicted example, the permeability is scored at the highest level (5) when the permeability exceeds a threshold and there are no natural fractures. The permeability is scored at the next highest level (4) when the permeability exceeds the threshold, but there are some natural fractures. The permeability may be scored at the mid-level (3) when the permeability is less than the threshold and there are many natural fractures. The permeability may be scored at the second lowest level (2) when the permeability is significantly less than the threshold, but there is some possibility to improve or enhance the permeability. Finally, the permeability may be scored at the lowest level (1) when the permeability is significantly below the threshold and there are no permeability enhancement options available.

With continued reference to FIG. 3, this particular example may grade a site as having the highest level (5) of water table when the water is under an impermeable layer and there is no public concern for groundwater and the lowest level (1) when there is no water. Intermediate levels may be determined based upon reported water table levels and the presence or absence of an impermeable layer. For example, the water table may be scored at the second highest level (4) when the water table is below an impermeable layer, but there is some public concern regarding groundwater. The water table may be scored at the mid-level (3) when the ore body is below the water table but there is no impermeable layer above. The water table may be scored at the second lowest level (2) when the ore body is only partially under the water table.

With still further reference to FIG. 3, this particular example may grade a site as having the highest level (5) of minability when the ore body includes an easy to leach mineral with no complications related to other minerals in the formation and the lowest level (1) when the minerals are not mineable or leachable. Intermediate levels may be determined based upon the particular minerals in the ore body and the ease of leaching those minerals as well as complications related to other minerals in the formation. For example, the site may be graded as having the second highest level (4) of minability when the mineral is readily leachable and there are only minor complications related to other minerals in the formation. Likewise, the site may be graded as having a mid-level (3) minability when the minerals are difficult to leach (e.g., requiring one or more lixiviants) but complications with respect to other minerals in the formation are manageable. The site may be graded as having the second lowest level of minability when the minerals are difficult to extract and require complicated and/or expensive treatment.

With yet further reference to FIG. 3, this particular example may grade a site as having the highest grade (5) ore when the mineral grade is greater than or equal to an upper threshold such as 2.5 percent and the lowest grade (1) when the grade is less than a lower threshold such as 0.125 percent. Intermediate levels may also be determined, for example, based on intermediate thresholds such as the levels tabulated. The disclosed embodiments are, of course, not limited to any particular tabulated threshold levels.

In this particular example, an overall or relative applicability score may also be determined, for example, with the highest level (5) being given when in situ leaching is the only possible approach to mining the ore body and it is clearly a viable economic approach. The lowest level (1) may be given when in situ leaching is not possible or is significantly more expensive than other approaches (e.g., when the ore body is located at or very near to the surface of the earth). Intermediate levels may also be given depending on the applicability of the particular mining technology and a corresponding comparison with other technologies. For example, a relative applicability score of (4) may be given when the in-situ leaching methodology is a better mining methodology overall but is only borderline economically viable. A relative applicability score of (3) may be given when the in-situ leaching methodology is possible (along with other mining approaches) but there is little distinction in yield, recovery rate, or production cost between the in-situ leaching methodology and other feasible mining methodologies. And a relative applicability score of (2) may be given when the in-situ leaching methodology is highly difficult to implement or likely to be more expensive than other methodologies.

Turning now to FIGS. 4A and 4B (collectively FIG. 4), example tabulated results are depicted for a potential mining site. In FIG. 4A, all of the necessary data/information was available and found in the reports such that full applicability scores (interpretations) could be computed for two related, but distinct, emerging mining technologies; in-situ leaching (ISL) and electrokinetic in situ leaching (EKS-ISL) in this particular example. The tabulated results were obtained using method 100 and system 250 using publicly available NI 43-101 reports, and the example criteria described above with respect to FIG. 3. As described above with respect to FIG. 3, the potential mining site (Mine A) was scored using five distinct criteria, with each of the emerging mining technologies receiving a five-level score for each of the criteria. An overall score was also given based upon the scores for each criteria using the following example equation:

$$Overall score = \{ \begin{matrix}1 ( if any criteria is 1 ) \\ Ave - 0.125 ( \# \leq 3 ) - 0.125 ( \# \leq 2 )\end{matrix} \}$$

Note that in this example, the overall score is computed in one of two different ways. First, if any one or more of the criteria received the lowest level score (1), then the overall score is set equal to 1. Otherwise, the overall score is computed as the average of the scores for each of the five listed criteria minus 0.125 times the number of criteria that receive a score of three or less and minus (again) 0.125 times the number of criteria that receive a score of two or less. In this particular example equation, the overall score tallies a penalty when one or more of the criteria received a score of three or less and a double penalty when one or more of the criteria receive a score of two or less. It will of course be understood that disclosed embodiments are not limited to any particular equations to compute an overall score. Nor are they limited to the use of an overall score criteria.

In this particular example, ISL and EKS-ISL received similar scores with the EKS-ISL receiving a higher permeability score. The ISL technique received an overall score of 3.35 which is equal to the average of the listed criteria scores (3, 4, 4, 3, and 4) minus 0.25 (since two of the criteria received a score of 3 or less). The EKS-ISL technique received an overall score of 3.675 which is equal to the average of the listed criteria scores (4, 4, 4, 3, and 4) minus 0.125 (since one of the criteria received a score of 3 or less).

FIG. 4B shows an example evaluation in which there was missing data or uncertain interpretation. In this example, the formation permeability was not able to be determined with certainty from the reports. A range of values (3 and 4) were assigned. It will be appreciated that this approach may be used for any criteria for which there is missing or uncertain data in the reports. This allows multiple applicability scores to be given. Moreover, as noted in the figure, the overall quality of the evaluation may be quantified using different metrics based upon the number of criteria for which there is uncertainty.

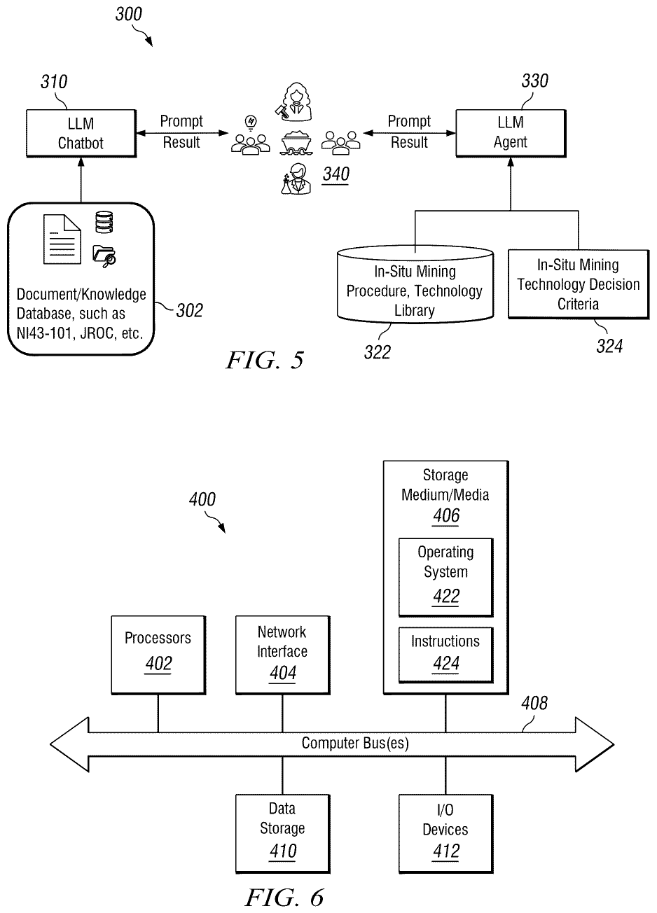

FIG. 5 depicts another example implementation 300 of a generative AI enabled workflow to identify mining sites where a mining technology may be applicable. A document containing database 302 may be interrogated using a large language model (LLM) chatbot 310 including preestablished queries. The queries may be as described above. A technology library 322 and a catalog of technology decision criteria 324 may be interrogated using an LLM agent 330 including preestablished criteria. The criteria may be as described above. The LLM chatbot 310 and the LLM agent 330 may be in further communication with a system user 340 to provide recommendations of the applicability of one or more mining technologies to a mining site. The system users 340 may include, for example, a major mining company, a small mining company, the dealer or mineral rights owner, a consulting and/or engineering firm, and/or a researcher.

FIG. 6 depicts an example computer system 400 that may be used to implement the disclosed methods and/or systems 100, 200, 250, 300 for evaluating a mining site as a potential target for a new mining technology. It will be appreciated that computing machines such as desktops, laptops, smartphones, tablets, etc. may have the structure of the computer system 400. Moreover, it will be further appreciated that the computer system 400 may include additional components not shown and that some of the process components described may be removed and/or modified. In another example, a computer system 400 may sit (or be hosted) on external-cloud platforms such as Amazon Web Services, AZURE® cloud or internal corporate cloud computing clusters, or organizational computing resources, etc.

Example computer system 400 includes processor(s) 402, such as a central processing unit, ASIC or another type of processing circuit, input/output devices 412, such as a display, mouse keyboard, etc., a network interface 404, such as a Local Area Network (LAN), a wireless 802.11x LAN, a 3G, 4G or 5G mobile WAN or a W Max WAN, and a processor-readable medium 406. Each of these components may be operatively coupled to a bus 408. The computer-readable medium 406 may be any suitable medium that participates in providing instructions to the processors) 402 for execution. For example, the processor-readable medium 406 may be a non-transitory or non-volatile medium, such as a magnetic disk or solid-state non-volatile memory or volatile medium such as RAM. The instructions or modules stored on the processor-readable medium 406 may include machine-readable instructions executed by the processor(s) 402 that cause the processors) 402 to perform the methods and functions of the disclosed methods and systems 100, 200, 250, 300.

The disclosed methods and systems 100, 200, 250, 300 for evaluating a mining site as a potential target for a new mining technology may be implemented as software stored on a non-transitory processor-readable medium and executed by one or more processors 402. For example, the processor-readable medium 406 may store an operating system 422, such as MAC OS, MS WINDOWS, UNIX, or LINUX, and code (instructions) 424 for the disclosed methods and systems. The operating system 422 may be multi-user, multiprocessing, multitasking, multithreading, real-time, and the like. For example, during runtime, the operating system 422 is running and the code 424 is executed by the processor(s) 402.

The computer system 400 may include data storage device(s) 410, which may include non-volatile data storage. The data storage 410 may be used to store the documents, queries, criteria, extracted data, and the information management system in FIG. 2. A network interface 404 may connect the computer system 400 to internal systems for example, via a LAN. Also, the network interface 404 may connect the computer system 400 to the Internet. For example, the computer system 400 may connect to web browsers and other external applications and systems via the network interface 404, for example, to acquire the mining documents.

With continued reference to FIGS. 1-6, it will be appreciated that the disclosed embodiments are intended to combine (a) an AI tool able to extract information from a publicly available mining project report (e.g., an NI 43-101, JROC, etc. report) and (b) well-defined, simple criteria for applicability (e.g., one question with Yes/No answer) of a given technology to (c) infer the applicability of the technology to the mining project. The method may be extended such that the information for one given mining project is extracted from multiple reports related to that project. The reports may be publicly available mining reports (e.g., NI 43-101, JROC, etc.) or non-publicly available mining project reports (e.g.: given company internal/proprietary reports).

In certain advantageous embodiments, the disclosed embodiments may make use of criteria for applicability that is non-binary (e.g., graded or scored as Easy, Doable, Challenging, Difficult, Impossible as above). Moreover, the disclosed embodiments may be extended such that the criteria for applicability includes the combination of multiple simple criteria (e.g., multiple questions instead of one question) and may include a final score that combines the multiple criteria. The method may be further extended to give a range or distribution of scores when specific pieces of information needed to determine applicability are unknown or partially known. In this way the method may give you a range or distribution of final scores.

The disclosed method may be executed by a technology owner, a site owner, or any other personnel to assess whether an emerging mining technology is suitable for a particular mining site. The method may also be executed by a technology owner to determine the size of a market and/or identify sales leads or generate product/service and/or pricing/advertisement materials or by an investor to determine mining properties whose value might be changing because the technology can or cannot be applied to them. The disclosed method may further make recommendations regarding steps to obtain missing data (when applicable) either through measurement, processing and/or interpretation of existing and/or new data, and/or use of modeling or geological analog. Acquisition of such missing data may then enhance a future evaluation of the mining site.

The disclosed embodiments may be extended to include modifying the criteria to account for Technology improvement and the method is re-run on the same report(s). The method may also be extended to include re-running the method with an improved (new) AI tool. The method may make use of substantially any suitable AI tools such as GenAI tools (e.g., ChatGPT) are used to extract information from the mining project reports and advanced AI tool (e.g., Visual Language Model) are used to extract information from the mining project reports text, image and tables.

Although an artificial intelligence method for evaluating a mining project has been described in detail, it should be understood that various changes, substitutions and alternations can be made herein without departing from the spirit and scope of the disclosure as defined by the appended claims.

We claim:

1. A method for evaluating a mining site as a potential candidate for application of an emerging mining technology, the method comprising:
acquiring at least one report that provides information about the mining site;
generating evaluation queries and criteria related to an application of the emerging mining technology to the mining site;
using an artificial intelligence (AI) based engine to extract query relevant information from the at least one acquired report;
classifying the extracted query relevant information using the generated criteria; and
generating an applicability score that assesses the viability of utilizing the emerging mining technology to mine the mining site.

2. The method of claim 1, wherein the emerging mining technology comprises at least one of in situ leaching, electrokinetic in situ leaching, and in situ biomining.

3. The method of claim 1, wherein the at least one report comprises a publicly available document.

4. The method of claim 3, wherein the at least one report comprises an National Instrument 43-101 compliant report.

5. The method of claim 1, wherein the criteria related to the application of the emerging mining technology to the mining site enable non-binary classification of the emerging mining technology.

6. The method of claim 1, wherein the AI based engine comprises a large language model configured to extract the query relevant information from text data in the at least one report.

7. The method of claim 1, wherein the AI based engine comprises a visual language model configured to extract the query relevant information from image-based data in the at least one report.

8. The method of claim 1, wherein the classifying comprises assigning a digital score to each of a plurality of the generated criteria.

9. The method of claim 8, wherein:
the emerging mining technology comprises at least one of in situ leaching, electrokinetic in situ leaching, and in situ biomining;
the generated criteria comprise at least permeability, water table, minability, mineral grade, and relative applicability of the emerging mining technology; and
the classifying comprises assigning a non-binary digital score to each of the generated criteria.

10. The method of claim 8, wherein the generating an applicability score further comprises computing an overall score for the mining site from the digital scores of each of the plurality of generated criteria.

11. A system for evaluating a mining site as a potential candidate for application of an emerging mining technology, the system comprising:
a document repository for storing at least one report that provides information about the mining site;
a listing of generated queries;
an artificial intelligence (AI) based engine configured to extract query relevant information from the at least one report;
a listing of generated classification criteria related to an application of the emerging mining technology to the mining site; and
an analytics processing module configured to classify the extracted query relevant information for each of the generated classification criteria.

12. The system of claim 11, wherein the AI based engine comprises at least one of a large language model configured to extract the query relevant information from text data in the at least one report and a visual language model configured to extract the query relevant information from image-based data in the at least one report.

13. The system of claim 11, wherein analytics processing module is configured to assign a digital score to each of a plurality of the generated criteria.

14. The system of claim 13, wherein the digital score is non-binary and the generated criteria comprise permeability, water table, minability, mineral grade, and relative applicability of the emerging mining technology to the mining site.

15. The method of claim 13, wherein the analytics processing module is further configured to compute an overall score for the mining site from the digital scores of each of the plurality of generated criteria.

16. A method for evaluating a mining site as a potential candidate for application of at least one of in situ leaching, electrokinetic in situ leaching, and in situ biomining, the method comprising:
acquiring at least one report that provides information about the mining site;
generating evaluation queries and criteria related to an application of at least one of in situ leaching, electrokinetic in situ leaching, and in situ biomining to the mining site, wherein the generated criteria comprise permeability, water table, minability, mineral grade, and relative applicability to the mining site;
using an artificial intelligence (AI) based engine to extract query relevant information from the at least one acquired report;
classifying the extracted query relevant information using the generated criteria and a non-binary classification; and
generating an applicability score that assesses the viability of utilizing the emerging mining technology to mine the mining site.

17. The method of claim 16, wherein the at least one report comprises a publicly available National Instrument 43-101 compliant report.

18. The method of claim 16, wherein the AI based engine comprises at least one of a large language model configured to extract the query relevant information from text data in the at least one report and a visual language model configured to extract the query relevant information from image-based data in the at least one report.

19. The method of claim 16, wherein the classifying comprises assigning a digital score to each of the generated criteria.

20. The method of claim 19, wherein the generating an applicability score further comprises computing an overall score for the mining site from the digital scores of each of the plurality of generated criteria.
